(19) United States
(12) Patent Application Publication
(10) Pub. No.: US 2026/0140375 A1
(43) Pub. Date: May 21, 2026

(54) ACTUATOR FOR HEAD-UP DISPLAY

(71) Applicant: HYUNDAI MOBIS CO., LTD., Seoul (KR)

(72) Inventor: Byung Ki KIM, Yongin-si (KR)

(73) Assignee: HYUNDAI MOBIS CO., LTD., Seoul (KR)

(21) Appl. No.: 19/324,732

(22) Filed: Sep. 10, 2025

(30) Foreign Application Priority Data
Nov. 19, 2024 (KR) 10-2024-0165075

(51) Int. Cl. G02B 27/01; F16F 15/06; F16H 37/12

(52) U.S. Cl. CPC G02B 27/0149; F16F 15/06; F16H 37/126; G02B 2027/0154

(57) ABSTRACT

An actuator for head-up display including a link coupled with one end of an aspherical mirror, a driving force transmission including a lead screw to move the link, a driver to rotate the lead screw in a direction of a rotation axis of a motor according to driving of the motor a lead screw bracket coupled to the driver and supporting the driver, and a cantilever-type dynamic vibration absorber configured to connect the driver to the lead screw bracket and absorb vibration and shock in three axes.

### CROSS-REFERENCE TO RELATED APPLICATION

This application claims the benefit of and priority to Korean Patent Application No. 10-2024-0165075, filed on November 19, 2024, the entire disclosure of which is hereby incorporated herein by reference in its entirety.

### TECHNICAL FIELD

The present disclosure relates to an actuator for head-up display, and more specifically, to an actuator for head-up display that damps vibration using a cantilever-type dynamic vibration absorber.

### BACKGROUND

The content described in this section simply provides background information for the present disclosure and does not constitute prior art.

A head-up display is a device that displays images including vehicle speed, fuel level, and route guidance information on a windshield, which is a front window of a vehicle. The head-up display is generally configured to display information of display projected from a picture generation unit on a windshield.

The head-up display rotates an aspheric mirror using a motor. As Revolutions Per Minute (RPM) of the motor increases, the vibration of the motor, that is, the acceleration generated from the motor, increases. The head-up display according to the prior art discloses a technology that suppresses vibration of a motor using a dynamic vibration absorber made of a metal material such as brass.

However, the dynamic vibration absorber made of a metal material such as brass is formed with a larger mass than a motor and a motor mount that fixes the motor. Accordingly, the manufacturing cost of the actuator for head-up display increases, and there is a problem that the total weight of the actuator for head-up display increases.

In addition, the head-up display according to the related art has a problem that noise is generated because the vibration of the motor is not sufficiently attenuated when the motor is driven based on high RPM. In particular, since the head-up display of the related art does not effectively respond to low-frequency vibration, the vibration generated at low frequencies is transmitted to the entire head-up display, causing structural damage to the head-up display, increased noise, deterioration of system performance, and visual instability of the image.

### SUMMARY

A main object of an actuator for head-up display according to one embodiment is to reduce the manufacturing cost by using a cantilever-type dynamic vibration absorber and to minimize the total weight of the actuator for head-up display.

A main object of an actuator for head-up display according to one embodiment is to respond to low-frequency vibrations using the cantilever-type dynamic vibration absorber and attenuate vibration and noise of a motor.

The problems to be solved by the present disclosure are not limited to the problems mentioned above, and other problems not mentioned can be clearly understood by those skilled in the art from the description below.

According to an embodiment of the present disclosure, there is provided an actuator for head-up display comprising a link configured to be coupled with one end of an aspherical mirror, a driving force transmission including a lead screw configured to move the link, a driver configured to rotate the lead screw in a direction of a rotation axis of a motor according to driving of the motor a lead screw bracket coupled to the driver and supporting the driver, and a cantilever-type dynamic vibration absorber configured to connect the driver to the lead screw bracket and absorb vibration and shock in three axes.

The driver may include: an upper end motor mount disposed in contact with one surface of an upper end of the motor; a lower end motor mount disposed in contact with a lower surface of a lower end of the motor; and a body disposed between the upper end motor mount and the lower end motor mount and covering at least a portion of a side surface of the motor.

The cantilever-type dynamic vibration absorber may include: a dynamic damping male screw coupled to penetrate a first hole formed through both ends of the upper end motor mount; a male screw that penetrates and connects a second hole formed through both ends of the lead screw bracket to correspond to the first hole; and a vibration absorber connecting the dynamic damping male screw to the male screw.

A length of the dynamic damping male screw may be adjusted according to vibration of the motor.

The vibration absorber may be a wire rope configured to provide elasticity and shock absorption.

The dynamic damping male screw may include: a first head including at least one first penetration hole through which the vibration absorber passes; and a first screw that extends from the first head, penetrates the first penetration hole, and extends downwardly of the motor.

The male screw may include: a second head that is disposed to correspond to the first head and includes at least one second penetration hole through which the vibration absorber passes; and a second screw that extends from the second head, passes through the second penetration hole, and extends upwardly of the motor.

The vibration absorber may comprise a metal material.

The second penetration hole may be disposed in a direction intersecting the first penetration hole, and the vibration absorber may be configured to pass through each of the first penetration hole and the second penetration hole so that the vibration absorber is twisted.

The first screw may be fastened with a first nut disposed downwardly of the motor, and the second screw may be fastened with a second nut disposed upwardly of the motor.

According to the actuator for a head-up display according to one embodiment, it is possible to reduce the manufacturing cost by using the cantilever-type dynamic vibration absorber and to minimize the total weight of the actuator for head-up display.

According to the actuator for a head-up display according to one embodiment, it is possible to respond to low-frequency vibrations using the cantilever-type dynamic vibration absorber and attenuate vibration and noise of a motor.

### BRIEF DESCRIPTION OF THE DRAWINGS

FIG. 1 is a perspective view illustrating an actuator for head-up display according to one embodiment of the present disclosure.

FIG. 2 is an exploded perspective view illustrating the actuator for head-up display according to one embodiment of the present disclosure.

FIG. 3 is a perspective view illustrating a first embodiment of a cantilever-type dynamic vibration absorber according to one embodiment of the present disclosure.

FIG. 4 is a perspective view illustrating a second embodiment of the cantilever-type dynamic vibration absorber according to one embodiment of the present disclosure.

FIG. 5 is a perspective view illustrating a third embodiment of the cantilever-type dynamic vibration absorber according to one embodiment of the present disclosure.

### DETAILED DESCRIPTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the gist of the present disclosure, the detailed description thereof will be omitted.

In describing the components of the embodiments according to the disclosure, reference numerals such as first, second, i), ii), a), and b) may be used. These reference numerals are merely used to distinguish the components from other components, and the nature, sequence, order, and the like of the components are not limited by the reference numerals. In the specification, when a portion is referred to as “comprising” or “including” a component, this means that other components may be further included instead of excluding other components unless explicitly stated to the contrary.

In describing components of the present disclosure, reference terms such as first, second, A, B, (a), and (b) may be used. These terms are only used to distinguish the components from other components, and the nature, sequence, order, or the like of that component is not limited by the terms.

When a component is described as being “connected”, “coupled” or “joined” to another component, it should be understood that the component may be directly connected or joined to the other component, but that another component may be “connected”, “coupled” or “joined” between each component.

The terms “portion”, “module”, and the like described in the specification mean a unit that processes at least one function or operation, and may be implemented by hardware or software, or a combination of hardware and software.

It should be noted that, unless otherwise stated, the description of one embodiment may be applied to other embodiments as well.

The description of the disclosure, disclosed with reference to the accompanying drawings, is intended to describe exemplary embodiments of the disclosure and is not intended to represent the only embodiments in which the disclosure may be practiced.

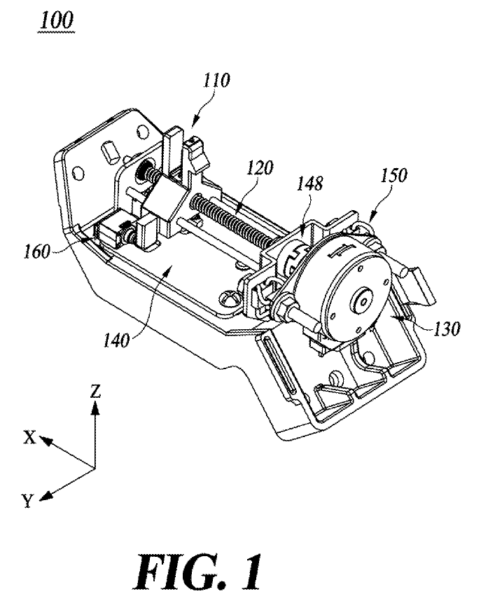

FIG. 1 is a perspective view illustrating an actuator for head-up display according to one embodiment of the present disclosure.

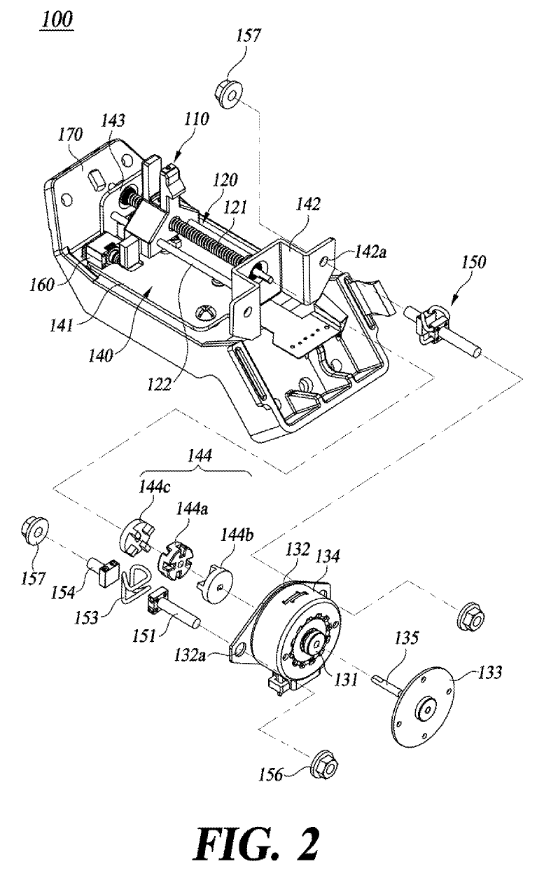

FIG. 2 is an exploded perspective view illustrating the actuator for head-up display according to one embodiment of the present disclosure.

Referring to FIGS. 1 and 2, the actuator for a head-up display according to one embodiment of the present disclosure includes some or all of a link 110, a driving force transmission 120, a driver 130, a lead screw bracket 140, and a cantilever type dynamic vibration absorber 150.

The link 110 may be coupled with an aspherical mirror (not illustrated) and the driving force transmission 120. The link 110 may be configured to be coupled with one end of the aspherical mirror. The link 110 may be disposed between the driving force transmission 120 and the aspherical mirror (not illustrated) to connect each component.

A spherical mount (not illustrated) may be formed at both ends of the aspherical mirror so that the aspherical mirror (not illustrated) can rotate. The link 110 may be linked with the driving force transmission 120 to rotate the aspherical mirror along an axis direction in which the spherical mount (not illustrated) rotates.

The driving force transmission 120 may include some or all of a lead screw 121 and a guide shaft 122. The driving force transmission 120 may move the other end of the link 110 in an arc.

The lead screw 121 may be extended and rotated to a rotating shaft of a motor 131, and may be formed as an integral part with the driving force transmission 120 or may be formed as a detachable structure that can be assembled to/separated from the driving force transmission 120. The lead screw 121 may move the link 110.

The guide shaft 122 may be formed parallel to the lead screw 121 and spaced apart from the lead screw 121 between a lead screw mount 143 and a dynamic damping mount 142. The guide shaft 122 may be coupled to penetrate a part of the link 110.

When the link 110 moves along the lead screw 121, the guide shaft 122 may guide the movement section so that the link 110 moves without rotating.

The driver 130 may include some or all of the motor 131, an upper end motor mount 132, a lower end motor mount 133, and a body 134.

The motor 131 may be a DC motor, an AC motor, an induction motor, a synchronous motor, a step motor, a servo motor, a brushless motor, a linear motor, a permanent magnet synchronous motor (PMSM), or the like.

The motor 131 may include a rotor shaft 135. The rotor shaft 135 may be formed to extend along the rotation axis of the motor 131. Here, the rotor shaft 135 refers to a central shaft that is coupled with a rotor, which is a component that performs rotational motion in the motor 131, and supports and transmits the rotational motion.

The upper end motor mount 132 may be disposed to be in contact with one surface of an upper end of the motor 131. Here, the upper end of the motor 131 refers to an area in contact with the shaft of the motor 131. The upper end motor mount 132 may be formed to cover the entire upper end of the motor 131.

The upper end motor mount 132 may be formed to extend along a direction perpendicular to the axial direction of the motor 131.

The lower end motor mount 133 may be disposed to be in contact with contact one surface of a lower end of the motor 131. The lower end motor mount 133 may be formed to cover the entire lower end of the motor 131. The lower end motor mount 133 may be manufactured using a thin metal plate.

The body 134 may be formed between the upper end motor mount 132 and the lower end motor mount 133. The body 134 may be configured to cover the entire side surface of the motor 131. The body 134 may be formed to be connected to the upper end motor mount 132. However, the shape of the body 134 is not limited thereto.

The lead screw bracket 140 may include some or all of a housing mount 141, a dynamic damping mount 142, and a lead screw mount 143.

The lead screw bracket 140 may be disposed on the upper end of the motor 131. The lead screw bracket 140 may be coupled to the driver 130 to support the driver 130.

The housing mount 141 may be disposed in contact with one surface of a housing 170. The housing 170 may fix an actuator for head-up display 100 to the inside of the head-up display. The housing 170 may include a plurality of bosses (not illustrated) and a plurality of holes (not illustrated) for fixing the position of the housing mount 141.

The plurality of bosses (not illustrated) may determine the position at which the housing mount 141 is coupled to the housing 170. A housing hole (not illustrated) may be formed on one surface of the housing mount 141 so that a tapping screw can pass through the housing mount 141. The tapping screw may pass through the housing hole (not illustrated) and be fastened to the plurality of holes (not illustrated) formed on one surface of the housing 170.

A flexible cable may be disposed between the housing 170 and the bracket of the motor 131. The flexible cable refers to a conductive wire connected to the motor 131. The flexible cable may be installed so as to be exposed in all directions on the left and right sides based on the housing 170.

A switch 160 may be disposed in one area of the housing mount 141. The switch 160 may detect a driving limit of the aspherical mirror.

The dynamic damping mount 142 may be disposed adjacent to the upper end motor mount 132. The dynamic damping mount 142 may be formed by being vertically bent to the housing mount 141.

A hole may be formed on one surface of the lead screw mount 143 so that the lead screw 121 may penetrate and be coupled. The lead screw mount 143 may be formed by being bent vertically to the housing mount 141.

The flexible coupling 144 may compensate for the eccentricity between the rotation axis of the motor 131 and the rotation axis of the lead screw 121. The flexible coupling 144 may be coupled with a first hub 144b and a second hub 144c on both sides centered on a spacer 144a.

The rotating shaft of the motor 131 may be fit-coupled to the first hub 144b coupled to one side of the flexible coupling 144. The lead screw 121 may be fit-coupled to the second hub 144c coupled to the other side of the flexible coupling 144.

Even when the rotation axis of the motor 131 and the rotation axis of the lead screw 121 do not coincide, the eccentricity between the axes can be compensated by using the spacer 144a. The flexible coupling 144 according to one embodiment of the present disclosure may be, for example, an Oldham coupling. Here, the Oldham coupling is used as a coupling for compensating for the eccentricity between the axes coupled on both sides. However, the type of the flexible coupling 144 is not limited thereto.

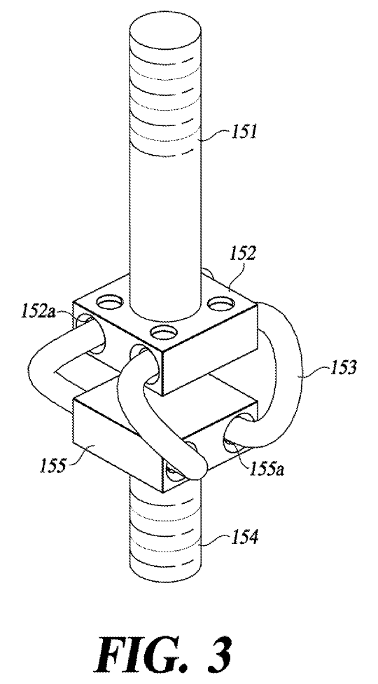

FIG. 3 is a perspective view illustrating a first embodiment of a cantilever-type dynamic vibration absorber 150 according to one embodiment of the present disclosure.

Referring to FIG. 3, the cantilever-type dynamic vibration absorber 150 may include all or part of a dynamic damping male screw 151, a male screw 154, and a vibration absorber 153.

The cantilever-type dynamic vibration absorber 150 may be configured to connect between the driver 130 and the lead screw bracket 140 and absorb vibration and shock in three axes. Specifically, the cantilever-type dynamic vibration absorber 150 may connect between the upper end motor mount 132 and the dynamic damping mount 142.

The dynamic damping male screw 151 may be coupled to the upper end motor mount 132 by penetrating through a first hole 132a formed in one area of both ends of the upper end motor mount 132.

The dynamic damping male screw 151 may include all or part of a first head 152 and the first screw 151a.

The first head 152 may include at least one first penetration hole 152a formed so that the vibration absorber 153 may pass through the first head 152. Specifically, the first head 152 may be disposed between the upper end motor mount 132 and the dynamic damping mount 142 in the upper direction of the motor 131.

In addition, the first head 152 may be formed relatively wider than the first screw 151a and fixed so as to be tightly fixed to the upper end motor mount 132. This is an exemplary configuration description and is not necessarily limited thereto.

The first screw 151a may extend from the first head 152 and pass through the first hole 132a. The first screw 151a may be formed to extend in the lower direction of the motor 131.

The first head 152 and the first screw 151a may be formed as an integral body. Therefore, the durability against external impact is strengthened, and the production process can be simplified to improve cost efficiency.

The first screw 151a may be fastened with a first nut 156 disposed in the lower direction of the motor 131.

The length of the dynamic damping male screw 151 may be adjusted according to the vibration of the motor 131. That is, the dynamic damping male screw 151 has a cantilever shape by adjusting the length of the dynamic damping male screw 151 in the axial direction. Specifically, the length of the first screw 151a can be adjusted. That is, the length of the first screw 151a may be determined based on the amplitude and frequency of the vibration generated from the motor 131. The length of the first screw 151a may be adjusted so that the natural frequency of the motor 131 and the natural frequency of the cantilever-type dynamic vibration absorber 150 match each other.

The male screw 154 may include all or part of a second head 155 and a second screw 154a.

The male screw 154 may be connected by penetrating a second hole 142a formed in one area of both ends of the lead screw bracket 140. Specifically, the male screw 154 may be connected by penetrating the second hole 142a formed in one area of both ends of the dynamic damping mount 142. The second hole 142a may be disposed to correspond to the first hole 132a.

The second head 155 can include at least one second penetration hole 155a formed to allow the vibration absorber 153 to pass through. Specifically, the second head 155 may be disposed between the dynamic damping mount 142 and the upper end motor mount 132 in the lower direction of the motor 131. Therefore, the second head 155 may be disposed to correspond to the first head 152.

In addition, the second head 155 may be formed relatively wider than the second screw 154a and fixed in order to be tightly fixed to the dynamic damping mount 142. However, this is an exemplary configuration description and is not necessarily limited thereto.

The second screw 154a may extend from the second head 155 and penetrate the second hole 142a. The second screw 154a may be formed to extend in the upper direction of the motor 131.

The second head 155 and the second screw 154a may be formed as an integral body. Therefore, durability against external impact is enhanced, and the production process is simplified, thereby improving cost efficiency.

The second screw 154a may be fastened with a second nut 157 disposed in the upper direction of the motor 131.

The vibration absorber 153 may be configured to connect the dynamic damping male screw 151 and the male screw 154. Specifically, the vibration absorber 153 may be configured with a wire rope to provide elasticity and shock absorption.

The vibration absorber 153 may be configured with a metal material that provides strong durability and high tensile strength. In particular, the vibration absorber 153 may have a structure made by twisting multiple metal wires. Therefore, the vibration absorber 153 may have excellent flexibility and shock absorption as a vibration damper. Due to these characteristics, the vibration absorber 153 may effectively disperse and absorb vibrations and shocks occurring in various directions, thereby contributing to increasing the stability of the actuator for head-up display 100.

Stainless steel may be mainly used as the metal material of the vibration absorber 153, and stainless steel has excellent corrosion resistance and wear resistance, so that it can maintain stable performance without deformation or corrosion even when used for a long period of time. In addition, since stainless steel maintains its physical properties well even in high and low temperature environments, it provides reliability in various operating environments. However, this is an exemplary configuration description and is not necessarily limited thereto.

The second penetration hole 155a may be formed so as to be disposed in a direction intersecting with the first penetration hole 152a. Accordingly, the vibration absorber 153 may be configured to twist by passing through the first penetration hole 152a and the second penetration hole 155a, respectively. That is, when the vibration absorber 153 passes through intersecting and twisting, the force applied in each direction can be evenly distributed, thereby improving the stability of the actuator for head-up display 100. In addition, due to this twisted arrangement, the vibration absorber 153 can absorb and alleviate vibrations and shocks occurring in all axes of the left, right, up, down, and front and back.

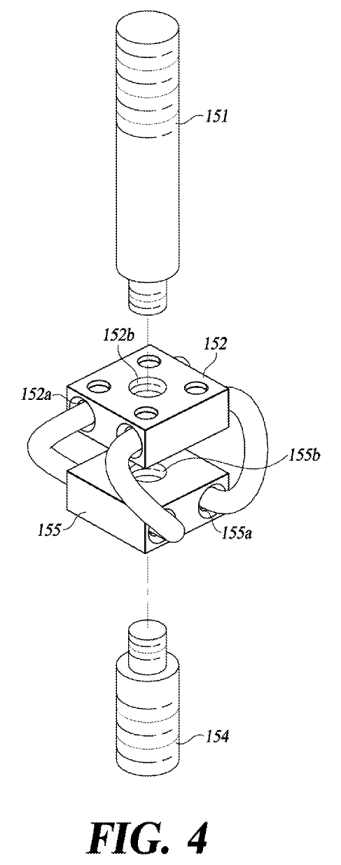

FIG. 4 is a perspective view illustrating a second embodiment of the cantilever-type vibration absorber 150 according to one embodiment of the present disclosure. Here, the descriptions overlapping with the first embodiment of the cantilever-type dynamic vibration absorber 150 according to the embodiment of FIG. 3 are omitted.

Referring to FIG. 4, the first head 152 and the first screw 151a of the dynamic damping male screw 151 may be formed in a separate form. A first screw 151b may be formed at the end of the first screw 151a to be connected with the first head 152.

A first coupling groove 152b may be formed on one surface of the first head 152 to be coupled with the first screw 151b. That is, since the first head 152 and the first screw 151a are configured in a separate form, only specific parts can be replaced during maintenance, thereby increasing efficiency. In addition, the structure in which the first screw 151b and the first coupling groove (152b) are coupled can be easily assembled and disassembled, thereby improving work convenience.

The second head 155 and the second screw 154a of the male screw 154 may be formed as separate types. A second screw 154b may be formed at the end of the second screw 154a to be connected with the second head 155.

A second coupling groove 155b may be formed on one surface of the second head 155 to be coupled with the second screw 154b. That is, since the second head 155 and the second screw 154a are configured as separate types, only specific parts can be replaced during maintenance, thereby increasing efficiency. In addition, the structure that is coupled using the second screw 154b and the second coupling groove 155b can be easily assembled and disassembled, thereby improving work convenience.

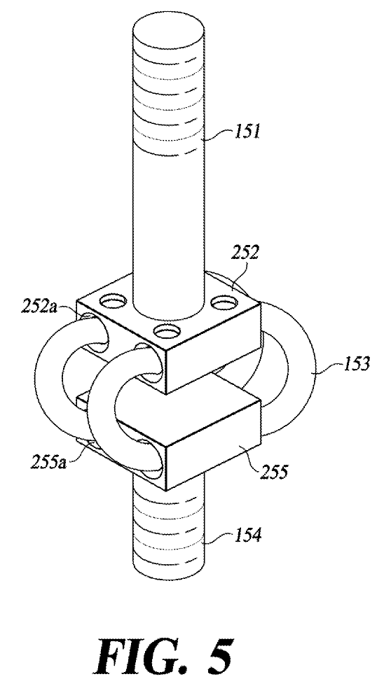

FIG. 5 is a perspective view illustrating a third embodiment of the cantilever-type vibration absorber 150 according to one embodiment of the present disclosure. The descriptions overlapping with the first and second embodiments of the cantilever-type dynamic vibration absorbers 150 according to the embodiments of FIGS. 3 and 4 are omitted.

Referring to FIG. 5, the second penetration hole 155a may be formed so as to be disposed in a direction parallel to the first penetration hole 152a. Accordingly, the vibration absorber 153 may be disposed in a straight line in a constant direction by passing through the first penetration hole 152a and the second penetration hole 155a, respectively. Accordingly, the vibration absorber 153 connected in a parallel and constant direction can more effectively respond to vibration and shock occurring in a specific direction.

The above description is merely illustrative of the technical idea of the present embodiment, and various modifications and variations will be possible to those skilled in the art without departing from the essential characteristics of the present embodiment. Therefore, the present embodiments are not intended to limit but to explain the technical idea of the present embodiment, and the scope of the technical idea of this embodiment is not limited by this embodiment. The protection scope of the present embodiment should be interpreted by the following claims, and all technical ideas falling within the scope equivalent thereto should be interpreted as being included in the scope of rights of the present embodiment.

What is claimed is:

1. An actuator for head-up display, comprising:
a link configured to be coupled with one end of an aspherical mirror;
a driving force transmission including a lead screw configured to move the link;
a driver configured to rotate the lead screw in a direction of a rotation axis of a motor according to driving of the motor;
a lead screw bracket coupled to the driver and supporting the driver; and
a cantilever-type dynamic vibration absorber configured to connect the driver to the lead screw bracket and absorb vibration and shock in three axes.

2. The actuator for head-up display of claim 1, wherein the driver includes:
an upper end motor mount disposed in contact with one surface of an upper end of the motor;
a lower end motor mount disposed in contact with a lower surface of a lower end of the motor; and
a body disposed between the upper end motor mount and the lower end motor mount and covering at least a portion of a side surface of the motor.

3. The actuator for head-up display of claim 2, wherein the cantilever-type dynamic vibration absorber includes:
a dynamic damping male screw coupled to penetrate a first hole formed through both ends of the upper end motor mount;
a male screw that penetrates and connects a second hole formed through both ends of the lead screw bracket to correspond to the first hole; and
a vibration absorber connecting the dynamic damping male screw to the male screw.

4. The actuator for head-up display of claim 3, wherein a length of the dynamic damping male screw is adjusted according to vibration of the motor.

5. The actuator for head-up display of claim 3, wherein the vibration absorber is a wire rope configured to provide elasticity and shock absorption.

6. The actuator for head-up display of claim 5, wherein the dynamic damping male screw includes:
a first head including at least one first penetration hole through which the vibration absorber passes; and
a first screw that extends from the first head, penetrates the first hole, and extends downwardly of the motor.

7. The actuator for head-up display of claim 6, wherein the male screw includes:
a second head that is disposed to correspond to the first head and includes at least one second penetration hole through which the vibration absorber passes; and
a second screw that extends from the second head, passes through the second hole, and extends upwardly of the motor.

8. The actuator for head-up display of claim 5, wherein the vibration absorber comprises a metal material.

9. The actuator for head-up display of claim 7, wherein the second penetration hole is disposed in a direction intersecting the first penetration hole, and
the vibration absorber is configured to pass through each of the first penetration hole and the second penetration hole so that the vibration absorber is twisted.

10. The actuator for head-up display of claim 7, wherein the first screw is fastened with a first nut disposed downwardly of the motor, and
the second screw is fastened with a second nut disposed upwardly of the motor.
